(19) United States
(12) Patent Application Publication
(10) Pub. No.: US 2006/0283313 A1
(43) Pub. Date: Dec. 21, 2006

(54) SYSTEM AND METHOD FOR MIDDLE C AND LOWER STRING TONE ENHANCEMENT FOR AN ACOUSTICAL PIANO

(76) Inventor: Peter H. Basralian, Houston, TX (US)

Correspondence Address: MARK YOUNG, P.A., 12086 FORT CAROLINE ROAD, UNIT 202, JACKSONVILLE, FL, 32225, US

(21) Appl. No.: 11/424,753

(22) Filed: Jun. 16, 2006

Related U.S. Application Data
(60) Provisional application No. 60/595,234, filed on Jun. 16, 2005.

(51) Int. Cl. G10H 1/32; G10H 3/00

(52) U.S. Cl. 84/744

(57) ABSTRACT

A string tone enhancement system enhances the string tones of an acoustic piano within a user-specified key range from the note titled “middle “c”” and lower by electronically producing supplemental sounds to accompany acoustical sounds of the piano. Electronically synthesized voices (i.e., tones) are generated and played in unison with the notes of the acoustical instrument within the key range. Sensors produce analog signals corresponding to actuated keys and pedals. Analog signals from the sensors are communicated to a signal processing module, which produces, in real time, audio output corresponding to actuated keys within the key range, such that audible speaker output occurs while the corresponding note is being played.

### RELATED APPLICATION

This application claims the benefit of priority of U.S. Provisional Application 60/595,234, filed Jun. 16, 2005, the entire contents of which are incorporated herein.

### FIELD OF THE INVENTION

This invention relates to acoustic pianos and, more particularly, to a system and method for middle “c” and lower tone enhancement using a user configurable electronic sound production module with capability of emulating, in real time, high-quality concert grand piano sounds.

### BACKGROUND

Modern acoustic pianos come in two basic configurations—the grand piano and the upright piano, in various sizes. Grand pianos have the frame and strings placed horizontally, with the strings extending away from the keyboard. The smallest grand piano, called a petite or baby grand, starts at about five feet long. The largest concert grand can be up to ten feet in length. Length is important because, in general, the longer the strings, the more resonant the sound and majestic the tone. The superior sound of a concert grand is particularly pronounced for middle “c” and lower keys (i.e., keys to the left of middle “c”). However, such performance comes at a high price. Grand designs, particularly concert grand pianos, are expensive, consume a large amount of space and require a spacious room with high ceilings for proper resonance.

Upright pianos, also called vertical pianos, are more compact than grand pianos because the frame and strings are placed vertically. While the very best upright pianos may now approach the level of grand pianos of the same size in tone quality and responsiveness, they still fall short of the majestic tone and resonant sound attainable with a concert grand. The deficiency is particularly noticeable for middle “c” and lower notes.

Consequently, heretofore, those who lack the space or resources for a concert grand are typically relegated to a smaller and somewhat inferior sounding grand or upright designs. As a consequence of the foregoing, there exists a longstanding need for a new and improved system and method for enhancing the sound of an acoustic piano, particularly baby grand and upright pianos. The system should be readily adaptable to conventional acoustic pianos, easy to configure, retrofittable to any (including old) pianos, and cost effective.

The invention is directed to overcoming one or more of the problems and solving one or more of the needs as set forth above.

### SUMMARY OF THE INVENTION

To overcome one or more of the problems and fulfill one or more of the needs as set forth above, in one aspect of an exemplary embodiment of the invention a string tone enhancement system is provided. The system enhances the string tones of an acoustic piano within a user-specified key range from “middle “c”” and lower by electronically producing supplemental sounds to accompany acoustical sounds of the piano. Electronically synthesized voices (i.e., tones) are generated and played in unison with the notes of the acoustical instrument within the key range. Sensors produce analog signals corresponding to actuated keys and pedals. Analog signals from the sensors are communicated to a signal processing module, which produces, in real time, audio output corresponding to actuated keys within the key range, such that audible speaker output occurs while the corresponding note is being played.

In one aspect of an embodiment of the invention, the system further includes an amplifier and at least one speaker. The amplifier is configured to receive and amplify the audio output signals from the signal processing module and to produce amplified audio output. The speakers are operably coupled to the amplifier to produce audible sounds corresponding to the amplified audio output.

In another aspect of an embodiment of the invention, the signal processing module includes a controller and a sound module. The controller produces MIDI output corresponding to sensor signals within the key range.

In yet another aspect of an embodiment of the invention, the signal processing module includes means, such as switches, for user-specification of the assignable key range, including a software switch for setting the highest note of the key range upon activation of a corresponding key of the piano, and a software switch for setting the lowest note of the key range upon activation of a corresponding key of the piano.

Thus, a system for middle “c” and lower tone enhancement for an acoustic piano may include a plurality of sensors operably configured to produce sensor signals corresponding to activated keys of the acoustic piano. The sensors may comprise a an optical, mechanical, infrared and/or piezoelectric sensor strip. A signal processing module is configured to receive sensor signals and produce, in real time, audio output signals corresponding to sensor signals for activated keys within a determined key range. The determined key range includes less than all of the keys on the acoustic piano. An amplifier and at least one speaker are also provided. The amplifier is configured to receive and amplify the audio output signals from the signal processing module and to produce amplified audio output, and the speaker is operably coupled to the amplifier to produce audible sounds corresponding to the amplified audio output. The audible sounds enhance the acoustic piano. The sensors are operably configured to produce sensor signals corresponding to activation of keys of the acoustic piano only within the key range. A user control may be provided for user-specification of a highest key in the key range and the lowest key in the key range. The user control may comprise a software switch.

The signal processing module includes a controller configured to receive sensor signals for activated keys and determine if the sensor signals correspond to keys within the key range. An analog to digital converter may also be provided to convert analog sensor signals for activated keys to digital data. The signal processing module may also include a database associating sensor signals with audio output signals for providing lower tone enhancement for an acoustic piano. A controller may be configured to produce MIDI data for activated keys if the signals for the activated keys correspond to keys within the key range corresponding to the activated keys. Audio output signals are configured to emulate concert piano sounds includes complex harmonic interactions for activated keys within the key range. The audio output signals are also configured to accompany acoustical sounds produced by activated keys within the key range. A second audible sound generation device may optionally be provided.

Additionally, a retractable keyboard may be provided in the opening between the pin block and the action of an acoustic piano. The additional keyboard may be comprised of mechanical keys and a sensor strip adapted to generate signals corresponding to keys played on the retractable keyboard.

### BRIEF DESCRIPTION OF THE DRAWINGS

The foregoing and other aspects, objects, features and advantages of the invention will become better understood with reference to the following description, appended claims, and accompanying drawings, where:

The foregoing and other aspects, objects, features and advantages of the invention will become better understood with reference to the following description, appended claims, and accompanying drawings, where:

FIG. 1 is a plan view of an exemplary piano keyboard with a line drawn at middle “c” and an arrow pointing to the notes lower than (i.e., to the left of) middle “c”; and

FIG. 2 is a high level block diagram of an exemplary system adapted to a baby grand piano according to principles of the invention; and

FIG. 3 is a high level block diagram of an exemplary system for middle “c” and lower tone enhancement using an electronic sound production module according to principles of the invention.

Those skilled in the art will appreciate that the figures are not intended to be drawn to any particular scale. The invention is not limited to any particular type of piano or the exemplary embodiments depicted in the figures or the shapes, relative sizes or proportions shown in the figures.

### DETAILED DESCRIPTION

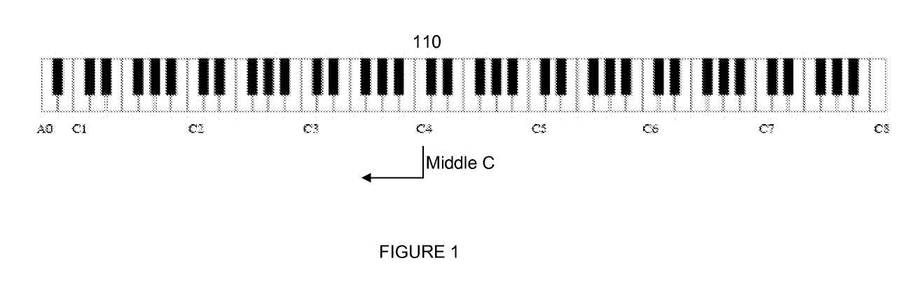

A piano's action (i.e., the entire mechanism required for propelling the hammers against the strings) includes the keyboard, a row of keys manipulated by the fingers. A conventional acoustic piano includes 88 keys, 52 white and 36 black keys. These are separated into seven full octaves plus three extra notes on the low end, starting on A. The lowest pitch, A0, is on the left, and the highest pitch, C8, is on the far right. In the center of the piano keyboard are two black keys. The white key C4 to the left of them is called middle “c”, as shown in FIG. 1. Referring to FIG. 1, a plan view of an exemplary piano keyboard 110 with a line drawn at middle “c” and an arrow pointing to the notes lower than (i.e., to the left of) middle “c” is provided.

As a pianist plays a tune on a conventional piano keyboard, hammers are selectively driven and strike associated music strings. The music strings vibrate, generating acoustic piano tones.

An object of the invention is to enhance the string tones of any acoustic piano from “middle “c”” to the lowest note. In a preferred implementation of the invention, supplemental sounds are electronically generated to accompany and enhance the sounds of keys played from middle “c” and lower. This is accomplished by introducing certain electronically synthesized voices (i.e., tones) which are to be played in unison with the notes of the acoustical instrument. The middle “c” and lower keys benefit greatly from enhancement because their sound noticeably differs from the rich sound of a concert grand piano. The electronically generated tones (also referred to as voices) can be of various type, and adjusted in amplitude, velocity, attack/release, timbre and tuning to compliment the acoustic piano so as to generate a combined sound that beautifies the original acoustic instrument to a new dimension of sound, performance and listening pleasure when played in unison. While notes higher than middle “c” also differ from concert grand notes, the difference is less perceptible, and therefore not enhanced by this invention.

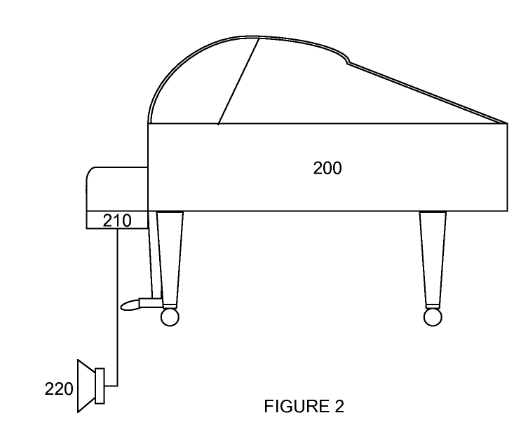

In an exemplary implementation, a piano 200 according to principles of the invention is equipped with sensors for sensing actuation of monitored keys and pedals. Electrical signals (e.g., analog and/or digital signals) from the sensors and corresponding circuitry are communicated to a signal processing module, as conceptually shown in FIG. 2. The signal processing module 210 produces audio output which is communicated to speakers 220 in real time, such that the speaker output occurs while the corresponding note is being played.

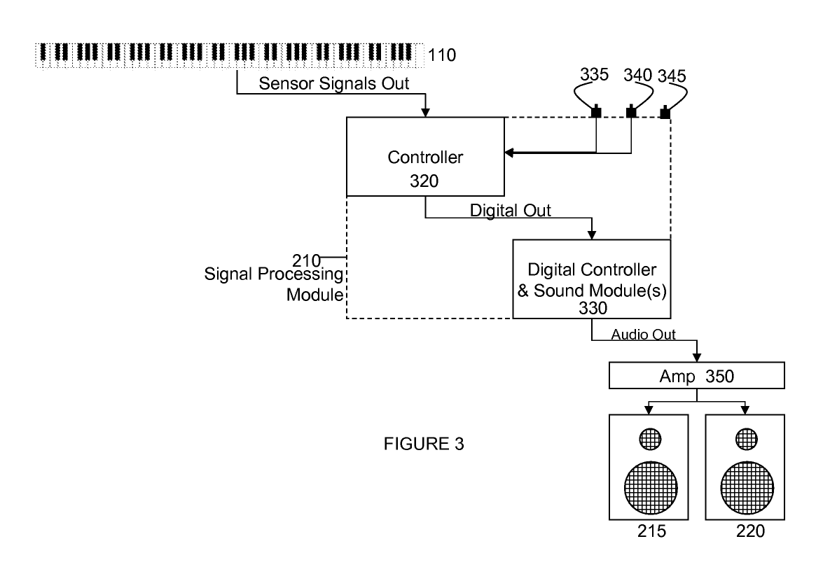

Various types of acoustic piano sensors now known or hereafter developed may be utilized. By way of illustration and not limitation, in one embodiment an array of optical, mechanical, infrared or piezoelectric sensors comprising a sensor strip are located above or below the piano keyboard and/or adjacent to the hammers of a piano. One example of such a sensor strip is the Gulbransen MIDI 9 SS88 sensor strip, available from Midi 9<Midi9.com>. Such sensors detect motion of the keys, without interfering with the feel and action. The sensors produce signals corresponding to key activation. The sensor signals are then communicated to the signal processing module 210 for processing, as conceptually shown in FIG. 3.

The signal processing module 210 includes a controller 320 configured to receive input signals from the sensors and determine if the signals correspond to keys within a set key range. In an exemplary embodiment, sound enhancements are produced to accompany activated keys within the key range. If the input signals include analog signals, the controller will include an analog-to-digital converter to convert the signals to digital form. In such case, the signals may be processed in real-time by an analog-to-digital converter (ADC), creating a binary (digital) output corresponding to the activated keys. However, if the input signals are digital, then the converter may be unnecessary. Processing circuitry in the controller 320 may include a digital signal processor (DSP), a microprocessor and memory. Digital signals corresponding to activated keys flow into the processing circuitry, which is configured to determine each activated note, the velocity and other sensed characteristics. The controller 320 is also configured to produce output data based upon the determined note, velocity, and other characteristics as well as preprogrammed and/or user input specifications.

In an exemplary implementation, the controller 320 is configured to produce a data stream for concert piano sounds including harmonic interactions corresponding to activated keys within a key range. An extensive database provided in the controller may be used to lookup the precise harmonic content of any note played, at any velocity level, and with any other sensed factors that affect the sound produced. Whenever a note is played, the controller analyzes the velocity of the key-strike and other pertinent factors and constructs, in real-time, a model of the necessary harmonic content for that particular note played at that velocity within the key range. Interpolation may be used to provide smooth and seamless transition between stored values.

In an exemplary implementation, the controller 320 is configured to process MIDI data. The MIDI protocol provides a standardized and efficient means of conveying musical performance information as electronic data. MIDI data is transmitted in MIDI messages comprised of a status byte which is generally followed by one or two data bytes. Thus, the controller 320 may be configured to process a MIDI data stream in real time (i.e., as keys are played).

The signal processing module 210 also includes a digital controller and sound module 330 configured to receive a data stream from the controller 320 and produce analog audio output corresponding to the activated keys of the piano and programmed sound information. An internal sound generator stores an array of high quality sound information that can be played with the acoustic piano keys. In an exemplary implementation, the stored information includes information for concert piano sounds including harmonic interactions corresponding to activated keys within a key range. Sounds produced therewith, layered with the sound of the acoustic piano, add an exciting new dimension to playing. The sound module may also be configured to produce special effects, such as delay, echo, and special waveform (e.g., sawtooth) effects.

Thus, the sensors feed signals to the controller 320, which determines notes and velocities and produces output data. The digital controller and sound module 330 produces analog audio output (also referred to in the art as voices) based on the output data and stored sound information. The audio output may then be adjusted to a listener's playing preferences and passed to a sound system, which may include an amplifier 350 and one or more speakers 215 and 220 for generation of corresponding audible musical tones via electro-acoustic conversion.

Configurability is an important aspect of a system for middle “c” and lower tone enhancement using an electronic sound production module according to principles of the invention. After the signal processing module 210 has been installed and connected to the sensor strip installed in the piano, the signal processing module 210 is powered on together with the audio amplifier, which is initially set to a low level. Next, the pianist maps the “lowest note” below middle “C” desired to be played by selecting “lowest note” 335 on the signal processing module 210 and then momentarily depressing that corresponding lowest note on the piano. A switch 335 or other means of user selection may be utilized to make the selection. After releasing the lowest note and switch 335, the pianist selects “highest note” 340 below middle “C” and then depresses that corresponding note on the piano. A switch 340 or other means of user selection may be utilized to make the selection. This creates a “Key Range” wherein the effect will be produced. This key range is stored in memory of the signal processing module 210 and may be reset by the pianist at any time. Thus, a user specifies the key range for enhancement. In an exemplary implementation, the polyphony of the signal processing module 210 is sixty-four (64), and as such, up to sixty-four voices (notes) can sound simultaneously. Thus, a system according to principles of the invention detects activation of and enhances keys within the key range using the electronic sound production module 210. Keys outside of the set key range are played acoustically without enhancement from the electronic sound production module 210. Advantageously, the means for setting the key range conveniently enables application of acoustic enhancement to notes within the highest note to lowest note range. Thus, each user may conveniently tailor the range of enhancement to suit that user's preferences for a piano. A user may also readily adjust the key range to experiment and determine an optimum range.

After setting the key range, a pianist selects a synthesized voice (e.g., concert grand piano) to sound with the acoustic instrument. A switch 345 or other means of user selection may be utilized to make the selection. Having done so, the pianist then adjusts the volume of the amplifier 350 and begins playing.

All pedal functions of the acoustic piano activate the electronic sound production module when depressed with notes in the selected key range. Pedal sensors (not shown) interface with the electronic sound production module 210. Pedal functions of the acoustic instrument continue to function in their normal manner.

Another important advantage of the invention is that it is configurable to produce sound enhancements in real time t0 accompany acoustic sounds of a piano within the key range.

Yet another important advantage is that the enhancements can be configured to emulate concert piano sounds, including complex harmonic interactions. In other words, the invention allows all of the complex harmonics normally produced by a concert grand piano to be faithfully produced within the key range. This means that a note's individual sound enhancement may be slightly different depending upon other factors such as which other notes are currently being held, (and consequently which strings are un-damped and free to resonate in sympathy). All factors that affect the sound of a note may be monitored by sensors and utilized to produce the desired sound enhancement. Such additional factors may even include activation of keys outside the key range. Illustratively, if a pianist holds a low “C” and lets the note decay, the strings for that note are still un-damped for as long as the key remains depressed. If a pianist then strikes another “C” higher up the keyboard, (staccato), a listener will hear the sympathetic resonance of the low “C” strings in response to the new note played. Moreover, by way of example, the complex harmonic and dynamic changes which take place in a concert grand piano as a pianist increases or decreases the velocity of a key-strike on a piano may also be faithfully emulated. Thus, the exemplary implementation of the invention may replicate exactly what happens on a grand piano within a key range. The result is musically and technically accurate simulation of a concert grand piano within the key range.

Those skilled in the art will appreciate the principles of the invention may be readily applied to various other embodiments. For example, components may be added to the system to provide additional functionality. Various inputs and outputs may be provided for each component of the invention. Illustratively, one or more MIDI sequencers, sound modules, other appropriately equipped instruments and MIDI PC interface cards may be operably coupled to the system to expand the functional capabilities without departing from the scope of the invention.

In one additional embodiment, a system according to the principles of the invention is configured for layering, a technique in which multiple sounds are utilized for each note played. The controller 320 may include one ore more outputs configured for communicating MIDI data over a determined channel to another device (i.e., a second sound generation device). The data is received by the other device, such as a synthesizer, set to the determined MIDI channel. Upon receiving the data, the device produces sound signals corresponding to the played note. A sound module then produces analog audio output based on the sound signals. This allows the pianist to build rich, complex, layered sounds.

In yet another embodiment, an acoustical grand piano may be manufactured or retrofitted with an additional (secondary) retractable keyboard according to the principles of the invention. The additional keyboard may be located in an opening between the pin block and action of the piano without causing interference. Retraction hardware is provided to enable accessing and storage of the additional keyboard. In a preferred implementation, the additional keyboard is comprised of mechanical keys and a sensor strip. The sensor strips generate signals corresponding to notes played on the additional keyboard. The sensor signals may then be communicated to one or more MIDI devices such as modules for signal processing and sound production. Such devices produce sound signals and audible output corresponding to the played note. Thus, the additional keyboard allows the pianist to produce another range of sounds.

While an exemplary embodiment of the invention has been described, it should be apparent that modifications and variations thereto are possible, all of which fall within the true spirit and scope of the invention. With respect to the above description then, it is to be realized that the optimum relationships for the components of the invention and steps of the process, including variations in form, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A system for middle “c” and lower tone enhancement for an acoustic piano, said system including
a plurality of sensors operably configured to produce sensor signals corresponding to activated keys of the acoustic piano;
a signal processing module configured to receive sensor signals and produce, in real time, audio output signals corresponding to sensor signals for activated keys within a determined key range, said determined key range including less than all of the keys on the acoustic piano; and
an amplifier and at least one speaker, said amplifier being configured to receive and amplify said audio output signals from the signal processing module and to produce amplified audio output, and said at least one speaker being operably coupled to said amplifier to produce audible sounds corresponding to the amplified audio output, said audible sounds enhancing for an acoustic piano.

2. A system for middle “c” and lower tone enhancement for an acoustic piano according to claim 1, wherein said sensors are operably configured to produce sensor signals corresponding to activation of keys of the acoustic piano only within the key range.

3. A system for middle “c” and lower tone enhancement for an acoustic piano according to claim 1, further comprising a user control configured for user-specification of a highest key in the key range, said lowest key in the key range being the lowest key on the acoustic piano, said key range being all keys from the highest key in the key range to the lowest key in the key range.

4. A system for middle “c” and lower tone enhancement for an acoustic piano according to claim 1, further comprising a user control configured for user-specification of a highest key in the key range and lowest key in the key range being the lowest key on the acoustic piano, said key range being all keys from the highest key in the key range to the lowest key in the key range.

5. A system according to claim 1, further comprising a user control configured for user-specification of a highest key in the key range, said lowest key in the key range being the lowest key on the acoustic piano, said key range being all keys from the highest key in the key range to the lowest key in the key range, and said user control comprising a software switch configured for setting the highest note of the key range upon activation of a corresponding key of the piano.

6. A system according to claim 1, further comprising a user control configured for user-specification of a highest key in the key range and a lowest key in the key range, said key range being all keys from the highest key in the key range to the lowest key in the key range, and said user control comprising a software switch configured for setting the highest note of the key range upon activation of a corresponding key of the piano, and configured for setting the lowest note of the key range upon activation of a corresponding key of the piano.

7. A system according to claim 1, wherein said signal processing module includes a controller configured to receive sensor signals for activated keys and determine if the sensor signals correspond to keys within the key range.

8. A system according to claim 1, wherein said sensor signals for activated keys are analog signals, and said signal processing module includes an analog to digital converter configured to convert sensor signals for activated keys to digital data, and a controller configured to receive said digital data and determine if the data corresponds to sensor signals for keys within the key range.

9. A system according to claim 1, wherein said plurality of sensors comprise a strip of sensors from the group consisting of optical, mechanical, infrared and piezoelectric sensors.

10. A system according to claim 1, wherein said sensor signals for activated keys are analog signals, and said signal processing module includes a database associating sensor signals with audio output signals providing lower tone enhancement for an acoustic piano.

11. A system according to claim 1, wherein said sensor signals for activated keys are analog signals, and said signal processing module includes a database associating sensor signals with audio output signals providing lower tone enhancement for an acoustic piano.

12. A system according to claim 1, said signal processing module comprises an analog-to-digital converter and controller configured to receive input signals from the plurality of sensors and to determine if the signals correspond to keys within the key range.

13. A system according to claim 12, said controller being configured to produce MIDI data for activated keys if the signals for the activated keys correspond to keys within the key range corresponding to the activated keys.

14. A system according to claim 1, wherein said audio output signals are configured to emulate concert piano sounds including complex harmonic interactions for activated keys within the key range.

15. A system according to claim 1, wherein said audio output signals are configured to accompany acoustical sounds produced by activated keys within the key range.

16. A system according to claim 1, further comprising a second audible sound generation device, and wherein said audio output signals are provided to the second audible sound generation device.

17. A system according to claim 1, wherein said acoustic piano includes a pin block and an action, with an opening therebetween, and said system further comprises a retractable keyboard located in the opening between the pin block and the action of the acoustic piano, said additional keyboard being comprised of mechanical keys and a sensor strip, the sensor strip being adapted to generate signals corresponding to keys played on the retractable keyboard.
